(19) United States
(12) Patent Application Publication
(10) Pub. No.: US 2018/0060485 A1
(43) Pub. Date: Mar. 1, 2018

(54) PRIVACY-PRESERVING SIMILAR PATIENT QUERY SYSTEMS AND METHODS

(71) Applicants: Indiana University Research and Technology Corporation, Indianapolis, IN (US); University of Maryland, College Park, College Park, MD (US)

(72) Inventors: Yan Huang, Bloomington, IN (US); XiaoFeng Wang, Bloomington, IN (US); Haixu Tang, Bloomington, IN (US); Xiao Wang, Greenbelt, MD (US)

(21) Appl. No.: 15/682,240

(22) Filed: Aug. 21, 2017

Related U.S. Application Data
(60) Provisional application No. 62/378,446, filed on Aug. 23, 2016.

(51) Int. Cl. G06F 19/28; G06F 19/00; G06F 21/62; G06F 19/22

(52) U.S. Cl. CPC G06F 19/28; G06F 19/22; G06F 21/6254; G06F 19/322

(57) ABSTRACT

Method including securely calculating, by a processor in electrical communication with a genome registry, an edit-distance between a query private genome and a second private genome, and securely calculating, by the processor, a set difference size between the query genome and the second private genome are disclosed. Systems capable of performing similar patient queries while preserving privacy are also disclosed.

### CROSS-REFERENCE TO RELATED APPLICATIONS

This application claims priority to and benefit of U.S. Provisional Application Ser. No. 62/378,446, filed on Aug. 23, 2013, the entire disclosure of which is hereby expressly incorporated by reference.

### GOVERNMENT SUPPORT

This invention was made with government support under 1464113, 1111599, 1223495, 1408874 awarded by the National Science Foundation and HG007078 awarded by the National Institutes of Health. The Government has certain rights in the invention.

### FIELD OF THE DISCLOSURE

This disclosure relates to systems and methods capable of performing similar patient queries while preserving privacy. More specifically, this disclosure relates to improved privacy-preserving searching of genomic information.

### BACKGROUND

The human genome includes two complementary strands, with around 3 billion DNA bases each. Each unit on the strand is a nucleotide (A, T, C or G). Between two randomly selected individuals, over 99% of their nucleotides are identical, with the rest different due to genetic variations. The most common variation involves only a single nucleotide, which can be either a major allele “0”, or a minor one “1”. Such a variation is called Single Nucleotide Polymorphism (SNP). About 50 million nucleotides in human genome are marked as SNPs, while two average individuals' genomes typically differ in 4-5 million variation sites.

The DNA data produced by a sequencer are in the form of a large number of short sequences, which are later assembled into a whole sequence by aligning each short sequence with a public reference genome. The differences between the sequence and the reference, including the nucleotide(s) changed, inserted or deleted at different genetic positions, are typically documented in a VCF (Variation Call Format) file. Conventionally, a genome-wide Similar Patient Query (SPQ) may actually take place on VCF representations of two genome sequences. Restricting the comparison to only a set of genetic markers for certain diseases often leads to inferior medical decisions, because, on the one hand, the state-of-the-art understanding of the association between diseases and genetic variations are dynamically improving, and on the other hand, many other variations, which are not part of the disease's genetic markers, could also affect a treatment decision (e.g., patients' reaction to a therapy, known as the pharmacogenomics markers).

For example, consider a physician seeking the best clinical decision for her patients. Invaluable to the effort is the information about how other similar patients respond to different therapies. As today's sequencing technologies have cut the cost of whole genome sequencing down to roughly $1,000 per person, it is highly anticipated that genome-based Similar Patient Queries (SPQ) will be used to identify similar patients from a large number of electronic medical records, through a health information exchange (HIE) system such as PatientsLikeMe® (a patient powered research network and trademark of PatientsLikeMe, Inc. a Delaware corporation), or other emerging systems like the Memphis HIE, Indiana HIE and Illinois HIE. Among the indicators of genetic similarity, edit-distance is one of the most important metrics, which is very useful in the biomedical research for the diagnosis and treatment of cancer, Alzheimer's disease, Schizophrenia, etc.

Standing in the way of deploying a national-scale, genome-wide SPQ system, however, is the privacy and liability concerns in the dissemination of such data. While unauthorized disclosure of personal genome data could cause serious harm to patients, such as denial of insurance, employment and education opportunities or blackmail, getting proper authorizations from millions of patients to share their data is not easy, due to its complicated procedure. Further, searching disease data solely relying on signed agreements can be less realistic in the near future, particularly when it comes to the secondary use (e.g., biomedical research). As a result, in the absence of scalable techniques that enable data use without exposing its content to unauthorized parties, the chance for any SPQ system to be deployed in practice is remote, with conventional systems and methods.

Secure Multi-Party Computation (SMC) has been identified as a potential solution for addressing such privacy challenges in supporting SPQ over distributed genomic datasets. Despite continuous performance improvements of secure computation in recent years, the scalability and performance of the conventional edit-distance based SPQ is still far from usable in supporting SPQ queries. The most efficient conventional SMC implementation can only compute the edit-distance between two sequences of a few thousands of base pairs, at a cost of hours of computing time and tens of gigabytes of bandwidth consumption. This is completely off the scale expected for a nationwide adaptation of the SPQ system.

A need therefore exists for systems and methods that will allow for a nationwide adaptation of a SPQ system to help improve health care.

### SUMMARY

In some embodiments, methods may include securely calculating, by a processor in electrical communication with a genome registry, an edit-distance between a query private genome and a second private genome, and securely calculating, by the processor, a set difference size between the query genome and the second private genome.

Systems may also include genomic registry data, a processor, and a non-transitory memory having instructions that, in response to an execution by the processor, cause the processor to calculate a query edit sequence from a reference genome and a query genome, and calculate a set difference size from the query edit sequence and a third party edit sequence stored on a server.

Also included within the scope of the disclosure include various embodiments of non-transitory computer readable storage mediums bearing instructions for determining an edit distance between genomes, the instructions, when executed by a processor in electrical communication with a genome registry, cause the processor to perform operations including calculating a query edit-distance from a reference genome to a query genome, and calculating, by the processor, a query set difference size between the query edit-distance and a server edit-distance, wherein the server edit-distance is calculated from a second genome on a server and the reference genome.

### BRIEF DESCRIPTION OF THE DRAWINGS

The above mentioned and other features and objects of this disclosure, and the manner of attaining them, will become more apparent and the disclosure itself will be better understood by reference to the following description of exemplary embodiments of the disclosure taken in conjunction with the accompanying drawings, wherein:

FIGS. 1A-B illustrate methods of calculating a set difference size between a query genome and a third party genome;

FIGS. 2A-B illustrate various methods of calculating a set difference size according to various embodiments;

FIG. 3A illustrates a system for genomic researching according to various embodiments;

FIG. 3B illustrates a system for genomic researching using cluster centers according to various embodiments;

FIG. 4 is a data table containing set difference size data from an experiment using exemplary protocol 1 according to various embodiments;

FIG. 5 is a data table containing set difference size data from an experiment using exemplary protocol 2 according to various embodiments;

FIG. 6 is a table comparing the time required to run both exemplary protocol 1 and protocol 2 with experimental genomes according to various embodiments;

FIG. 7 is a table comparing the thresholding set difference size of both protocol 1 and protocol 2 with experimental genomes according to various embodiments;

FIG. 8 illustrates an exemplary method for computing the median set difference according to various embodiments;

FIG. 9 also illustrates another exemplary method for computing the median set difference according to various embodiments; and

FIG. 10 illustrates an exemplary method for computing the square median set difference according to various embodiments.

Corresponding reference characters indicate corresponding parts throughout the several views. Although the drawings represent embodiments of the present disclosure, the drawings are not necessarily to scale and certain features may be exaggerated in order to better illustrate and explain the present disclosure. The exemplification set out herein illustrates exemplary embodiments of the disclosure, in various forms, and such exemplifications are not to be construed as limiting the scope of the disclosure in any manner.

### DETAILED DESCRIPTION

The embodiments disclosed below are not intended to be exhaustive or limit the disclosure to the precise form disclosed in the following detailed description. Rather, the embodiments are chosen and described so that others skilled in the art may utilize its teachings.

One of ordinary skill in the art will realize that the embodiments provided can be implemented in hardware, software, firmware, and/or a combination thereof. Programming code according to the embodiments can be implemented in any viable programming language such as C, C++, HTML, XTML, JAVA or any other viable high-level programming language, or a combination of a high-level programming language and a lower level programming language.

To enable patients to benefit from the soon-to-be-available, enormous amount of clinic genomic data, this disclosure includes systems and methods that enable secure SPQ based on the edit distance metric. Various approaches disclosed herein, called GENSETS (Genome-wide, Secure Patient Search), are capable of searching, for example, 250 hospitals each containing 4,000 patients (totally 1 million patients) across the nation within 200 minutes, by securely thresholding the edit distances over real genome data from breast cancer patients, as exemplified herein.

The systems and methods disclosed herein enable simple and effective edit-distance based SPQ designs. Unique features in human genome sequences are used in developing a highly accurate approximation of edit distance between genomes. More specifically, variations across the genome sequences of two average human individuals (even those associated with different genetic diseases) are dominated by nucleotide substitutions, with sporadic insertions and deletions scattered across the genome.

Second, by leveraging a public reference genome (so the variations of one's private genome from the reference genome can be locally computed) and pre-computed private variations, the edit distance between two private genomes can be efficiently approximated using set difference size from the (much shorter) private variations.

Third, the size of private set difference size can be securely approximated (without ever computing the private set difference size) using probabilistic algorithms. Furthermore, secure thresholding on the size of private set difference size can be computed even more efficiently without ever computing even the size of set difference.

Combining the aforementioned, the problem of private edit distance is converted into a much simpler problem of approximating the size of set difference. As exemplified herein, various embodiments demonstrate the efficiency of various embodiments of the systems and methods disclosed herein in a realistic continental network environment, and that the edit distance between the whole-genomes of two persons may be securely calculated in less than 40 seconds, at an error rate of 1.5%, while comparing the edit distance of two persons whole genomes. In various embodiments, with a threshold value, this may be accomplished at faster rates, consuming less than 0.9 seconds to achieve a 0.1% false positive/negative rate.

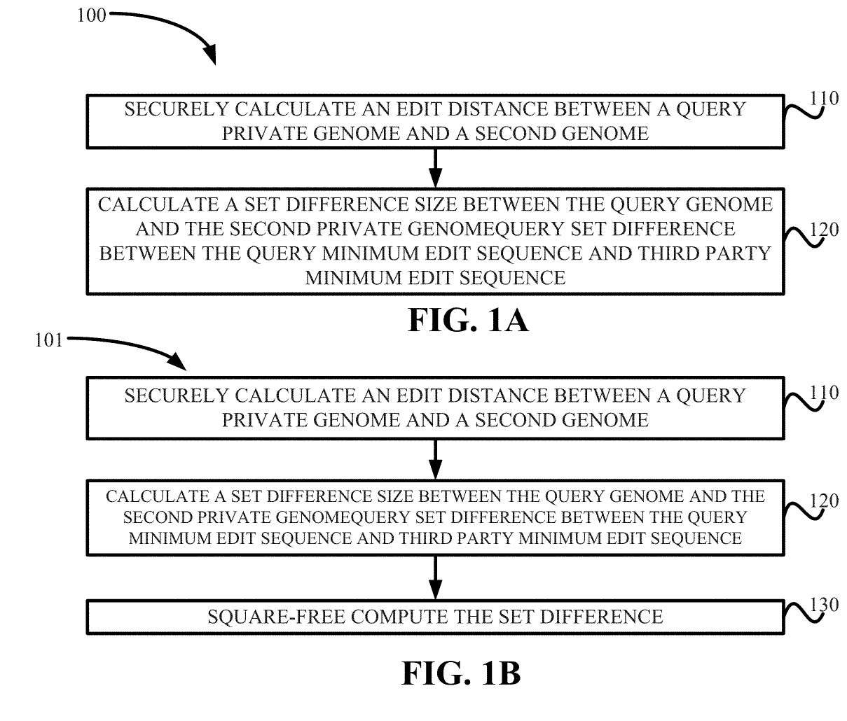

With reference to FIGS. 1A-B, various methods of calculating a set difference size between at least two genomes is exemplified according to various embodiments. Method 100 of FIG. 1A may include calculating, by a processor in electrical communication with a genome registry, a query edit-distance from a reference genome and a query genome (step 110). Then, the processor may calculate a set difference size between the query edit-distance and a third party edit-distance (step 120). In various embodiments, the third party edit-distance may be calculated from a third party genome and the reference genome. Thus, in various embodiments, methods may also include comparing the set difference size with a predetermined threshold.

Similarly, method 101 of FIG. 1B may include steps 110 and 120, but may also include square-free computing the set difference (step 130)

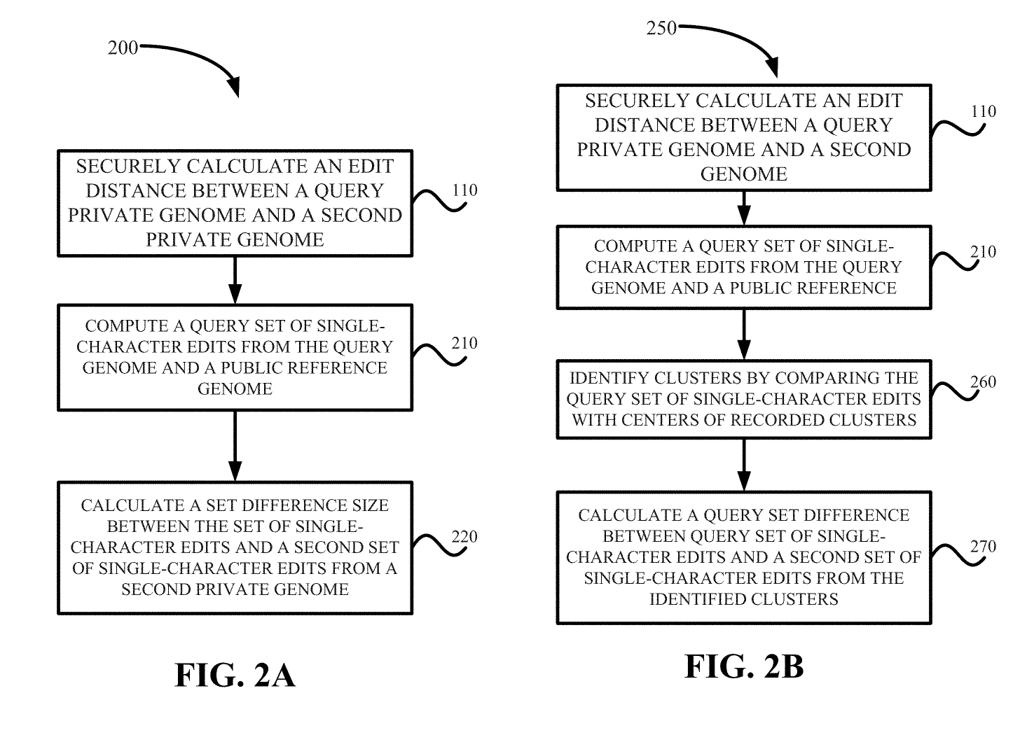

FIGS. 2A and 2B illustrate two exemplary methods of calculating a set difference size between two genomes. Method 200 may include securely calculating, by a processor, a query edit-distance from query private genome and a second private genome (step 110). Then, the processor may compute a query set of single-character edits from the query genome and a public reference genome (step 210) and calculate a set difference size between the set of single-character edits and a second set of single-character edits from a second private genome (step 220).

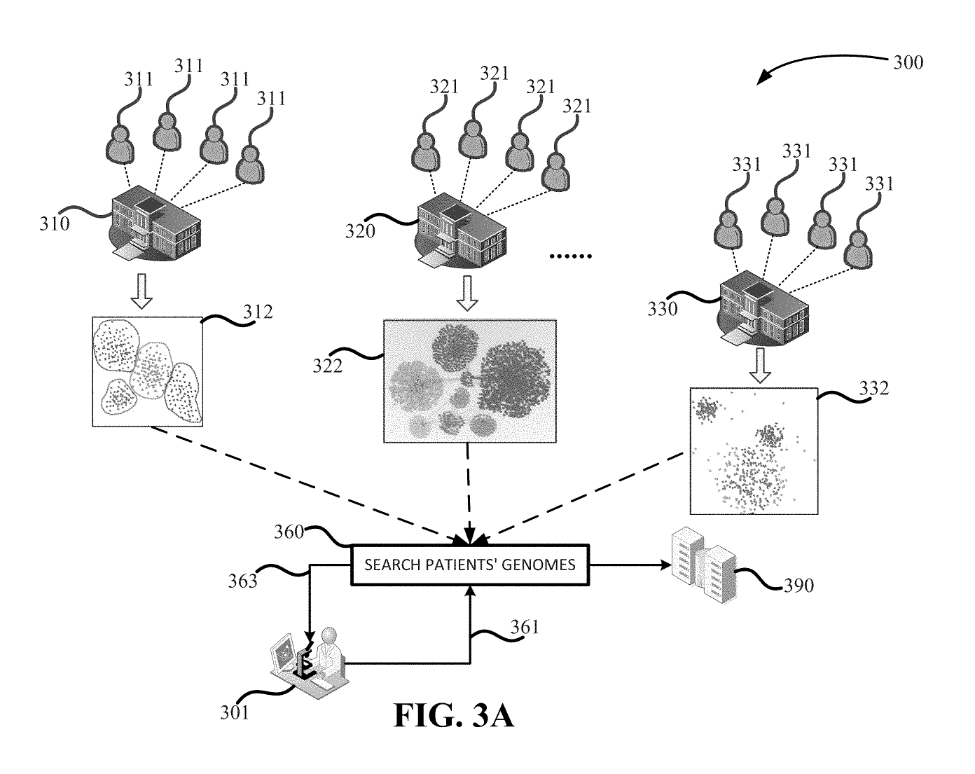

For example, with temporary reference to FIG. 3A, system 300 where genomic data and treatment from patients 311, 321, and 331 are collected by genomic centers 310, 320, and 330 (e.g., hospitals) is exemplified. The genomic data is then collected and stored in various clusters, as shown with genomic clusters 312, 322, and 332. A researcher 301 with electrical communication 361 may then run a query 360 on database 390 to determine suitable treatment options from similar patients, illustrated as results 363.

FIG. 2B illustrates method 250, which may include steps 120 and 210 similar to method 200, but may additionally include identifying, by the processor, clusters by comparing the query set of single-character edits with centers of recorded clusters (step 260). Then, the processor may calculate a set difference size between the query set of single-character edits and a second set of single-character edits from the identified clusters (step 270).

In other words, this secure SPQ (based on secure edit-distance) can potentially be deployed to support two-stage queries, in which hospitals will group their patients into clusters so that the first stage query identifies (by computing private edit distance between the query and the cluster center, which is a patient in the cluster) candidate clusters that contain similar patients; while the second stage only searches similar patients in those candidate clusters.

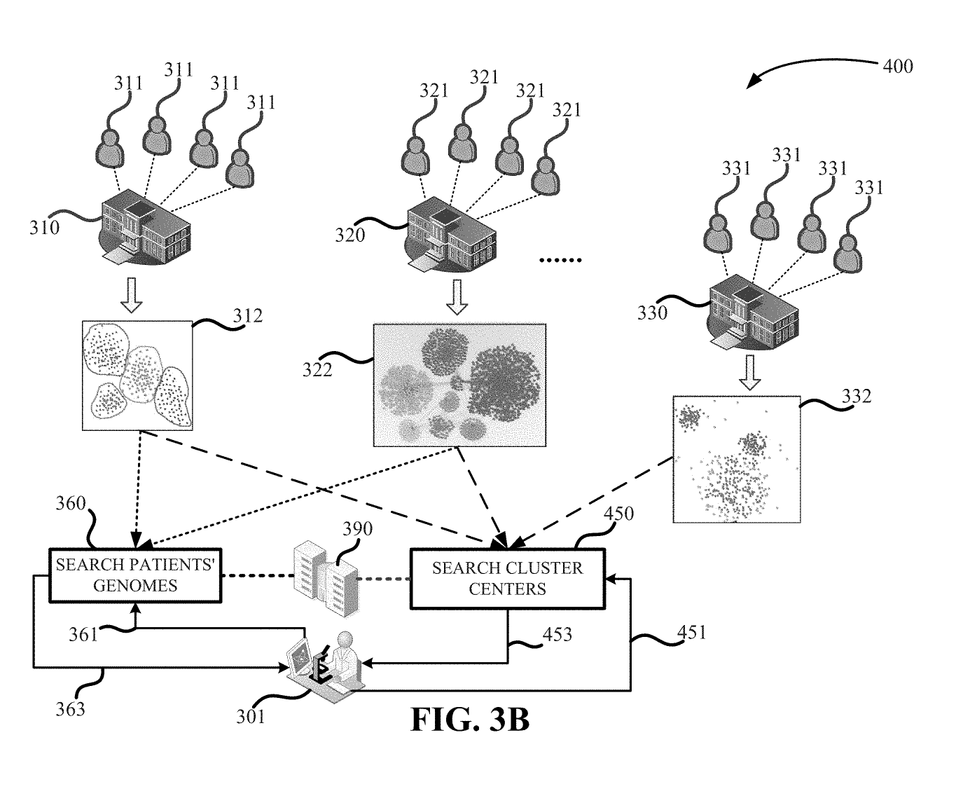

For example, with reference to FIG. 4, system 400 (of FIG. 3B) illustrates a system that searches suitable clusters. For example, similar to system 300 in FIG. 3A, genomic data, treatments, and medical records are collected from patients 311, 321, and 331 from genomic centers 310, 320, and 330 (e.g., hospitals). When researcher 301 with electrical communication 451 runs a query 450, the researcher is identifying, by the processor, clusters of single-character edits from the query edit-distance (step 260) from database 390. The processor may then identify clusters by comparing query set of single-character edits with centers of recorded clusters (step 260), illustrated as results 453. These clusters (e.g., genomic clusters 312 and 322) are then used in a second query 361, where the processor calculates a set difference size between the query edit-distance and a third party edit-distance from the identified clusters (step 270). Then, these results 363 are delivered to researcher 301.

Thus, with the pre-computed clusters, the whole SPQ may thus happen in two stages. In the first stage, the researcher 301 (e.g., the physician's secure SPQ client) runs the secure SPQ primitive with each hospital who supplies just the cluster centers (as exemplified in FIG. 3B as query 450), in order to identify all the hospitals that could have similar patients (e.g., has at least one cluster center close to the query). Thus, in various embodiments, the processor may identify preferred clusters by comparing a query set of single-character edits with centers of recorded clusters. Then, the second stage could be launched between the researcher and all candidate hospitals identified as a result of the first stage, to securely scan through all patients in these hospitals (exemplified as 360 in FIG. 4). In other words, the third party edit-distance may be selected from identified preferred clusters, which may be contained in the genome registry.

Various systems may also include genomic registry data contained in a server, a processor in electrical communication with the server and a non-transitory memory having instructions that, in response to an execution by the processor, cause the processor to calculate a query edit-distance from a reference genome and a query genome, and calculate a set difference size between the query edit-distance and a third party edit-distance, wherein the third party edit-distance is calculated from a third party genome and the reference genome. In various embodiments, instructions in the non-transitory memory may cause the processor to compute a set of single-character edits from the query edit-distance and/or cause the processor to identify preferred clusters by comparing a query set of single-character edits with centers of recorded clusters. Furthermore, the instructions in the non-transitory memory may cause the processor to compute a secure square set difference based on the query set difference size.

Thus, also disclosed herein are non-transitory computer readable storage medium comprising instructions for determining an edit distance between genomes, the instructions, when executed by a processor in electrical communication with a genome registry, cause the processor to perform operations comprising calculating a query edit-distance from a reference genome and a query genome, and calculating, by the processor, a set difference size between the query edit-distance and a third party edit-distance, wherein the third party edit-distance is calculated from a third party genome and the reference genome. Furthermore, in some embodiments (such as method 101 illustrated in FIG. 1b) the instruction may—when executed—cause the processor to calculate a secure square set difference (step 130).

The exemplary secure SPQ described in further detail below was implemented and evaluated over a real genome dataset consisting of 105 breast cancer patients (data obtained from dbGaP/TCGA with IRB approval (dbGap is “the database of Genotypes and Phenotypes”, TCGA is “the Cancer Genome Atlas”). SPQ experiments were run over a cross-country network. With a 100 Mbps network connection, GENSETS can accurately execute a SPQ query in less than 200 minutes to search through 1 million patients distributed in 250 hospitals (assuming each hospital has 4000 patients' records and that at most 5 candidate hospitals are selected to continue to the second stage). This result shows that the disclosed methods and systems enable a more practical implementation of secure SPQ.

The developed methods and systems illustrate a new approach to realize secure SPQ based on whole-genome edit-distance, attaining unprecedented high performance. This was done by using various features of human genome data and efficient probabilistic approximation algorithms, as demonstrated below. As exemplified below, efficient and scalable algorithms may help to enable various systems and methods to allow for the approximate edit-distance of human genomes with various probabilistic private set difference size protocols and an efficient, probabilistic private set difference size thresholding protocol. These, together with a new two-step SPQ search scheme, allows for the implementation and use of privacy-preserving SPQ.

The examples disclosed herein were implemented and evaluated it in a large-scale experiment using a realistic genome dataset.

### Secure Computation

Secure computation may allow several parties to jointly compute a function over secret input data supplied by each party, without using a trusted third party. The theory of secure computation is able to offer a security guarantee as strong as what can be achieved with a trusted third party (e.g., absolutely no information leak beyond what can be inferred from the desired outcome of the function). Since its inception in early 1980s, many constructions have been proposed, reducing the security guarantee either to the certain computational hardness assumptions, to the dominance of honest participants, or to the availability of a source of correlated randomness. Here, systems and methods were built and tested with the garbled circuit protocol. More recently, many cryptographic and implementational optimizations have been proposed that significantly improve the state-of-the-art of garbled circuit protocols.

Here, a semi-honest model was used, where the parties are trusted to always follow the protocol specification but would do arbitrary efficient side computations in an attempt to violate the security of the system. This model makes sense as launching an instance of a secure computation protocol alone already requires substantial level of trust among the participants, (e.g., through a mutual (but weaker flavor of) agreement). GENSETS is built around primitive SPQ protocols based on secure edit distance, which is arguably one of the most important biological similarity indicators. The edit distance between sequences A and B is defined as the minimum number of edits (i.e., insertion, deletion, or substitution of a single character is counted as one edit) to change A into B. Edit distance computation over generic input sequences requires quadratic time in terms of input length, which may not scale well on large inputs such as a human's whole genome sequence. Computing edit distance is especially challenging in the privacy-preserving setting because the state-of-the-art protocol computing the distance between two sequences of lengths of only 2K and 10K in a Giga-bits LAN setting requires more than 3.5 hours and 38 GB of network traffic.

Accordingly, the systems and methods disclosed herein contain various new secure protocols for edit distance. These protocols are orders-of-magnitude more efficient-20 seconds to securely compute (with an error rate of less than 1%) the edit distance between two whole-genomes (each containing roughly 3 billion bases) and merely 0.1 second to securely threshold (with reasonable false positive/negative rates) the edit distance between two whole-genomes.

While some methods and systems may have some errors, they are only at a very limited scale. It has been shown through experiments that such errors resulted from the secure edit distance protocol applied to real human genomes within 0.25-0.5% of the true values, while the false positive and false negative rate of the private edit distance thresholding protocol running on the realistic human genome dataset were within 0.01%.

As described above, each party agrees on a common public reference genome Ref and independently compresses local genomes with respect to Ref (by recording the minimum sequence of edits to derive itself from Re).

For example, given the public reference genome Ref to be GCACTGGCCTT, the genome sequence A=GCAATAGCCTTC can be denoted as a set A of operations, {(4, sub, A), (6, sub, A), (12, ins, C)} (i.e., the minimum edits to convert the sequence Ref into A). Due to the information redundancy in human genomes, this step can typically compress a genome string representation of about 3 billion base pairs into roughly 5 million edits (stored in a VCF file). The key insight is that the edit distance between two human genomes A and B can be approximated both efficiently and accurately, through comparing only the VCF file representation of their edits from a single common Ref. In this example, the set of edits (desirably) contains only single-character operations, while the VCF file for a real genome will contain multi-character operations.

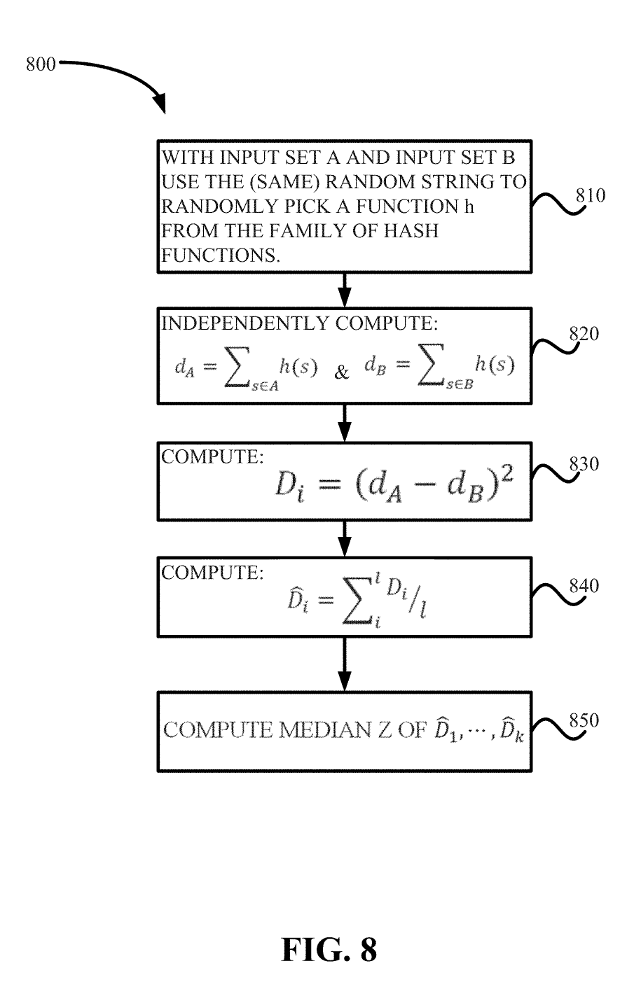

The various exemplary detailed algorithms illustrated in FIGS. 8-10 are capable of handling these complications and an extensive, empirical study of the accuracy of this approximation applied to human genomes. Once the sequence of edits in a VCF file is converted into a set of single-character edits, the edit distance of two genomes can be approximated by the size of the symmetric difference between the two sets of single-character edits associated with the two genomes.

For the purpose of handling whole-genomes, each single character-edit set typically contains 8-10 million edits. In various embodiments, due to the large amount of data being analyzed, the highly efficient private set difference size protocol exploiting the idea of probabilistic sketches may be used. Additionally, observing that the most frequent computation in various SPQ applications are actually comparing an edit distance to a threshold value, a secure set difference size thresholding protocol may be introduced, which runs another order-of-magnitude faster than a private set difference size protocol. All of these protocols related to private set difference size are generic and readily compatible with other secure computation protocols, and hence maybe of independent interest.

The notion of security offered by GENSETS is defined with respect to a relaxed variant of ideal world execution: upon receiving a query genome and a threshold t from the client and a list of genome strings from the database server, the trusted party generates a random string r and uses the approximation algorithm followed by applying a sketching algorithm with random tape r to compute all matching genomes in the server's list, and sending to the client both the matches and the random tape r.

### Private Edit Distance Approximation

It may be observed that the actual input strings to the edit distance computation in the SPQ application are distributed in a very special way. For example, for any two unrelated individuals, (1) much (more than 99.5%) of their DNA sequences are identical; (2) more than 95% of their edits (from the reference genome) occur at non-adjacent locations; (3) most (about 80-90%) of the edits between their genomes are substitutions. These statistical features are used in designing an efficient (and also very accurate) approximation of edit distance between human genomes.

Also, by using a public reference genome Ref, a significant portion of the computational task of private edit distance between any two human genomes can be moved into a pre-computable (and also amortizable) local preparation stage. Basically, each party may pre-compute locally the minimum edits from Ref to their respective private genomes, and then launch a secure computation protocol to approximate edit distance just from the private edits. Below are detailed approximation algorithms—according to various embodiments—followed by examples:

### Approximation Algorithms

The protocol involves two parties, each having a private human genome as input. The whole approximation algorithm has three steps:

1. Each party calculates the edit-distances from Ref to their own genomes. (in practice, edits of one genome (also known as variations) are stored in a VCF file.);

2. Each party computes a set of single-character edits from the edit-distance associated with their private genome. Namely, every multi-character edit e=(pos, op, aux) (where pos is the location of the edit, op is the type (either insert, delete, or substitute) of the edits, and aux represents operation-specific editing information) is decomposed into single-character edits as follows:
Inserts: Inserting a string c₁ . . . cₙ at location loc, denoted as (loc, ins, c₁ . . . cₙ), is translated into (loc, ins, 1, c₁), (loc, ins, 2, c₂), . . . , (loc, ins, n, cₙ).
Deletes: Deleting a string of length n at location loc, denoted as (loc, del, n), is translated into (loc, del, 1), (loc+1, del, 1), . . . , (loc+n−1, del, 1); and
Substitutes: Since substitutes are already defined with respect to a single character, no special treatment was used to break them down; and

3. The parties run a secure computation protocol to calculate the size of symmetric set difference between the two sets and output it as an approximation of the edit distance between the genomes. The symmetric set difference size between sets A and B, denoted as Diff(A,B), is defined as (A−B)∪(B−A).

In this particular exemplary embodiment, the first two steps only involve the public Ref and one party's genome, and hence is accomplished with relatively inexpensive local computation. Moreover, they are also amortizable in the sense that they need to be done only once in a preparation stage, no matter how many queries are to be serviced. Only the third step requires more expensive secure computation, whose design is detailed in the next two subsections.

### EXAMPLES

Suppose Ref=ATTGCCCGA; A=GTTGGA; B=GTTCGA. The minimum edits to convert Ref to A is {(1, sub, G), (5, del, 3)}, and to convert Ref to B is {(1, sub, G), (4, del, 3)}. Breaking down the edits into single-character edits, the two parties can respectively obtain set A′={(1, sub, G), (5, del, 1), (6, del, 1), (7, del, 1)} and set B′={(1, sub, G), (4, del, 1), (5, del, 1), (6, del, 1)}. Therefore, |Diff(A,B)|=2, which coincides with the edit distance between A and B.

Of course, there are cases where certain algorithms may not approximate very well or may have varying errors associated with an approximation. For instance, let Ref=ATTGCCCGA; A=GTTGGATAA; B=GTTCGATGA. In this case, the minimal sets of edits to obtain A and B from Ref are {(1, sub, G), (4, ins, C), (5, del, 1), (6, sub, A), (7, sub, T)} and {(1, sub, G); (5, sub, G), (6, sub, A), (7, sub, T), (8, sub, A)}, respectively. As A and B are already sets of single-character edits, it is obvious that |Diff(A,B)|=4, whereas the actual edit distance between A and B is 2. The error is caused when comparing the 4th and 5th character of A and B—while CG can be converted to GG with just a single sub operation, the approximation algorithm essentially accounts for it 3 times, namely, (4, sub, C) and (5, del, 1) for A and (5, sub, G) for B, because they were derived from Ref in different ways.

Fortunately, these types of “problematic” scenarios happen very rarely in practice, because on human genomes, most (90% of) edits obtained in step 1 are short edits (involving 1 to 2 nucleotides and the more problematic long-string, overlapping inserts and deletes almost never happen. Accordingly, a comprehensive empirical study of comparing the end-results of the approximation with the ground truth distance values obtained from an edit distance implementation using dynamic programming, over genome snippets of various lengths is shown below in Table 1:

TABLE 1

| Length of | Number | Relative Error | | |
|---|---|---|---|---|
| segments | of tests | 0.25% | 0.5% | 1% |
| 80 million | 10,000 | 78.15% | 99.13% | 100% |

To further illustrate the accuracy of this approximation, the edit distance between the genomes segments (each segment contains 8,000 nucleotides) of two randomly selected individuals in dataset of the Personal Genome Project (PGP) was computed and compared to the values with those produced by the estimation algorithm above. Because some embodiments having a rigorous dynamic programming may not be practical for the global alignment of genomic sequences with millions of bases, it is possible—in some embodiments—to first find long identically matched segments in the input genomic sequences, and then to chain the aligned segment into global alignment. In other words, the global edit distance may be approximated between two genome sequences by the sum of the edit distances between corresponding genome subsequences delineated by long identically matched segments. For comparing two human genomes with more than 99.5% identity, this sum-of-segment method may give the same edit distance as that computed by the rigorous dynamic programming algorithm.

For the examples used herein, the results of the sum-of segment method as the ground truth distance for the comparison with these approximations took 365 hours to compute the edit distance for 6,000 tests cases.

In each test, long segments were split into shorter subsequences of varying lengths (e.g., eight sequences of 1,000 nucleotides, four sequences of 2,000 nucleotides, and two sequences of 4,000 nucleotides) and then the true edit distance was calculated using dynamic programming algorithm and the approximation edit distance was calculated using these algorithms on segments and their subsequences. It was found in these examples that the edit distance between two 8,000-nucleotide sequences is always exactly the same as the sum of the two edit distance values over its two 4,000-nucleotide components; and the same observation applies to segments of length 4,000 and 2,000 as well.

These results show that, over real world human genome data, edit distance between long sequences can be accurately computed from the sum of distances on its subsequences.

Based on the observation above, the accuracy of the exemplary approximation algorithms on longer sequences (each containing around 80 million nucleotides) was analyzed by summing up distance values over 10,000 random basic segments (each containing around 8,000 nucleotides). The experimental results show that 99.13% of 10,000 tests exhibited an error rate of less than 0.5%, while all tests resulted in less than 1% error as shown in Table 1 above. These results demonstrate the accuracy of the exemplary approximation algorithms disclosed herein on real human genome data.

### Private Set Difference Size

The exemplary approximation algorithms reduce a private human genome edit distance problem to a private set difference size problem. Accordingly, below are exemplary protocols 800, 1, and 2 (illustrated in FIGS. 8, 9, and 10, respectively) for private set difference size.

### Protocol 800

FIG. 8 illustrates an exemplary protocol 800 according to various embodiments. Protocol 800 may first comprise, with an input set A and input set B, using the same random string to randomly pick a function h from a family of hash functions (step 810). In other words, every input set may first be compressed, say S, into a single integer ds, using a binary hash function h:U→{1, 1}), where U denotes the universe of all set elements.

More concretely, d_{A} and d_{B} were defined to be d_{A}=Σ_{sεA} h(s) and d_{B}=Σ_{sεB} h(s), which can be independently computed (step 820). If h can be randomly sampled from a family of pairwise independent binary hash functions, then for any element s, s₁, s₂ (sit s₂) and a randomly sampled h, E[h(s)]=0, E[h₂(s)]=1, and E[h(s₁)h(s₂)]=E[h(s₁)]·E[h(s2)]=0, with all probabilities taken over the randomness in sampling h.

Thus, for any set S,

$$\begin{matrix}E [ {d}_{s}^{2} ] = E [ {( {\sum }_{s ∈ B} h ( s ) )}^{2} ] \\ = E [ {\sum }_{s ∈ B} {h}^{2} ( s ) + 2 \cdot {\sum }_{{s}_{1} \neq {s}_{2}} h ( {s}_{1} ) h ( {s}_{2} ) ] \\ = E [ {\sum }_{s ∈ B} {h}^{2} ( s ) ] = \vert S \vert\end{matrix}$$

In some embodiments, d_{A}, d_{B} may represent the sketch integers computed from the two private input sets A and B, respectively. If the family of hash functions are four-wise independent (namely, for all distinct s₁, s₂, s₃, s₄, E[h(s₁)h(s₂)h(s₃)h(s₄)]=E[h(s₁)]E[h(s₂)]E[h(s₃)]E[h(s₄)]), then E [(d_{A}−d_{B})²]=|Diff(A,B)|. This is because d_{A}−d_{B}=Σ_{sεA} h(s)−Σ_{sεB} h(s)=Σ_{sεA-B} h(s)−Σ_{sεB-A} h(s).

Therefore,

$$E [ {( {d}_{A} - {d}_{B} )}^{2} ] = E [ {( {\sum }_{s ∈ A - B} h ( s ) )}^{2} + {( {\sum }_{s ∈ B - A} h ( s ) )}^{2} 2 \cdot ( {\sum }_{{s}_{1} ∈ A - B} h ( {s}_{1} ) ) ( {\sum }_{{s}_{1} ∈ B - A} h ( {s}_{2} ) ) ] = \vert A - B \vert + \vert B - A \vert + 2 \cdot 0 = \vert Diff ( A , B ) \vert .$$

To aid in binding any error, protocol 800 may estimate Diff(A,B) by computing the k-median of l-mean of random sampling of (d_{A}−d_{B})².

Thus, after step 820, the processor may run a secure protocol with respective private inputs dₐ and d_{b} to compute Dᵢ=(d_{A}−d_{B})²(step 830). Then the processor may compute \hat{D}ᵢ=Σᵢ^{l} Dᵢ/l (step 840). Then, the median Z of \hat{D}ᵢ, . . . , \hat{D}ₖ may be determined (step 850) and output Z.

### Protocol 1

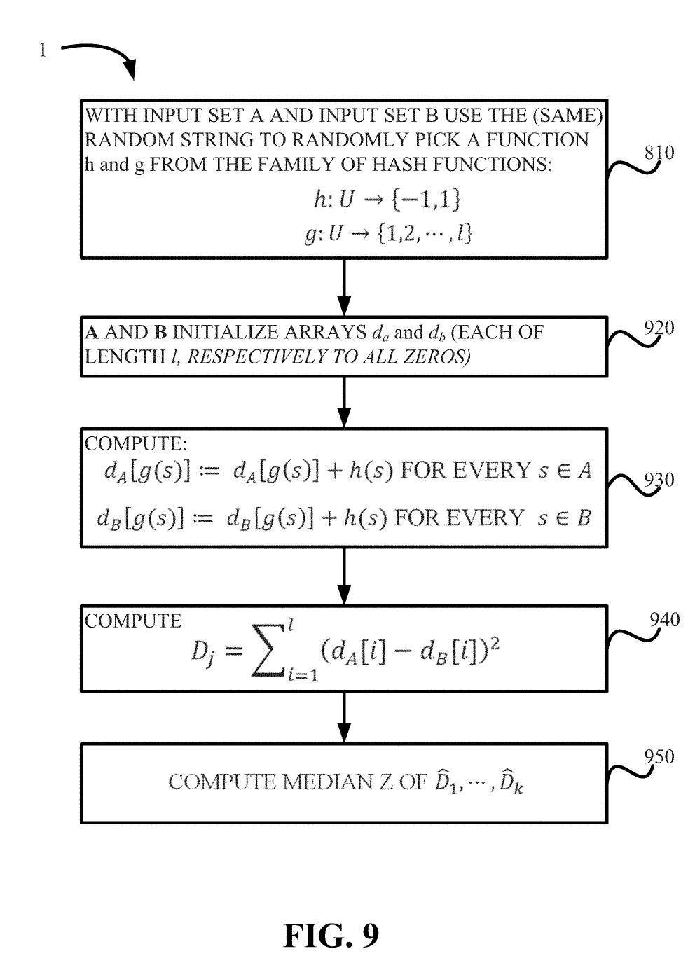

According to various embodiments, protocol 1 (shown in FIG. 9) may comprise, with an input set A and an input set B, using the same random string to randomly pick a function h from the family of hash functions (step 810) and initialize arrays dₐ and d_{b} (step 920). Protocol 1 may include computing d_{A}[g(s)]=d_{A}[g(s)]+h(s) for every s E A and d_{B}[g(s)]:=d_{B}[g(s)]+h(s) for every sεB (step 930). A and B may then run a secure computation protocol to securely compute Dⱼ=Σᵢ₌₁^{l}(d_{A} [i]−d_{B} [i])² (step 940) and compute the median Z of D₁, . . . , Dₖ (step 950).

The benefits of randomized bucketing, such as protocol 1, include reducing the number of local hashes and saving costs in secure computation stages. Since the number of times the accumulators d_{A}[i] and d_{B}[i] are incremented is reduced by 1, the number of bits (ω) in d_{A}[i]; d_{B}[i] is then reduced by log l, which saves substantial cost (30 to 40%) in the secure computation stage. Thus, in various embodiments, sorting may include a sorting algorithm selected from the group consisting of a bucket sort, a counting sort, and a radix sort.

For example, in various embodiments, the third party edit-distance may be bucketed. In some embodiments, every set element may be associated with a separate bucket.

### Protocol 2

As is mentioned earlier, secure squaring accounts for the dominant cost of the secure computation part of the protocol. Fortunately, under an extra assumption that (d_{A}−d_{B}) is very close to normal distribution, it can be shown that E|(d_{A}−d_{B})|=σ\sqrt{2/π} (where σ²=E|(d_{A}−d_{B})²|−(E[|d_{A}−d_{B}|])²) because |d_{A}−d_{B}| is a half-normal distribution. Thus, measuring E|(d_{A}−d_{B})| suffices to provide a good estimation of E[(d_{A}−d_{B})²]. Because |(d_{A}−d_{B})| is a binomial distribution, it is indeed very close to normal distribution as the set difference sizes observed in the genomic SPQ application were much larger than 10,000.

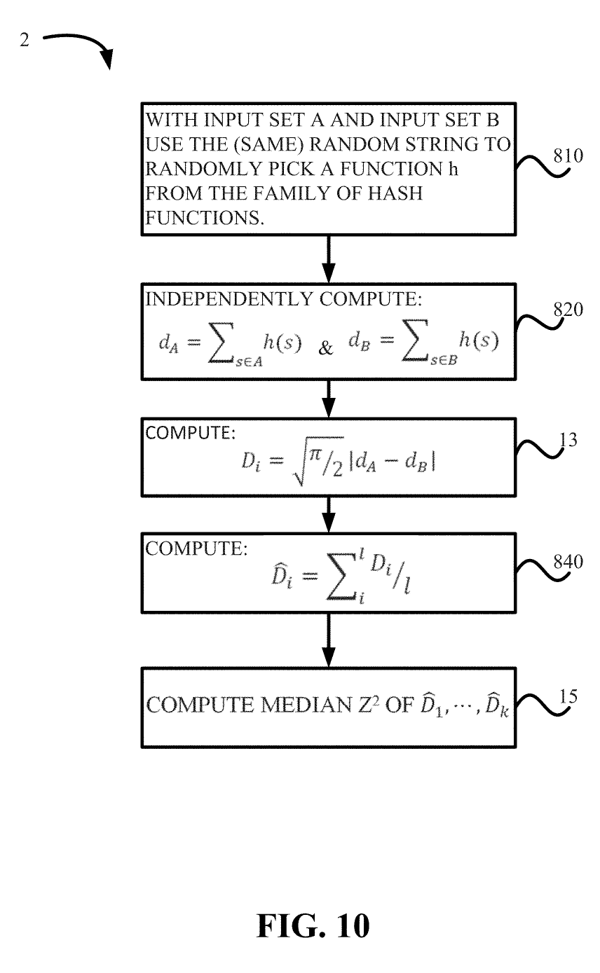

FIG. 10 illustrates protocol 2 based on this observation (and the extra assumption that the size of set difference is not too small). Similar to protocol 800, protocol 2 may include steps 810, 820, and 840, as shown in FIG. 10. Protocol 2 may also include running a secure computation protocol with inputs dₐ and d_{b}, respectively, to compute Dᵢ=\sqrt{π/2}|d_{A}−d_{B}| (step 13) and also securely computing the median Z² of \hat{D}ᵢ, . . . , \hat{D}ₖ (step 15) and output Z².

It was found that—in some embodiments—secure thresholding protocols may result in less error compared to the corresponding private set difference size protocols from which they are derived, due to a difference in the notion of error: 1% error in the size of set difference implies the estimated value is 1% away from the true value; while 1% error in thresholding the size actually means the chance to arrive at a wrong decision is 1%. As a result, smaller parameters (k, l values) suffice to achieve the same level of accuracy. The results of various experiments to evaluate the performance and accuracy of the aforementioned secure thresholding protocols are illustrated in FIGS. 4-7 (discussed in further detail below).

### System and Network

Unless explicitly specified otherwise, all experiments were performed between two machines located more than 2000 miles apart (one in Bloomington, Ind. and the other in San Diego, Calif.). The bandwidth is about 100 Mbps with variations. A garbled circuit and oblivious transfer protocols were used with a single thread. Multi-core parallelism was also used to compute the amortizable precomputed hashing phase of sketch construction.

The implementation of the garbled circuit protocol leverages half-gate garbling and free-XOR technique. The oblivious transfer is implemented using NPOT with OT extension.

### Metrics

In this evaluation, the following metrics were used to measure the accuracy and efficiency of the approach:

1. False positive/negative rate. A false positive refers to the event that a patient dissimilar to the query is returned; while a false negative happens when a similar patient is not returned.

2. Error rate. Error rate measures the accuracy of private set difference size protocols. It is defined to be |u−v|/u where u denotes the true size and v is what the secure protocol outputs.

3. Number of AND gates. With garbled circuit protocol, the main cost grows linearly with the number of AND gates in the circuit.

4. Wall-clock time. This is the total elapsed time of a task.

### Thresholding Private Set Difference Size

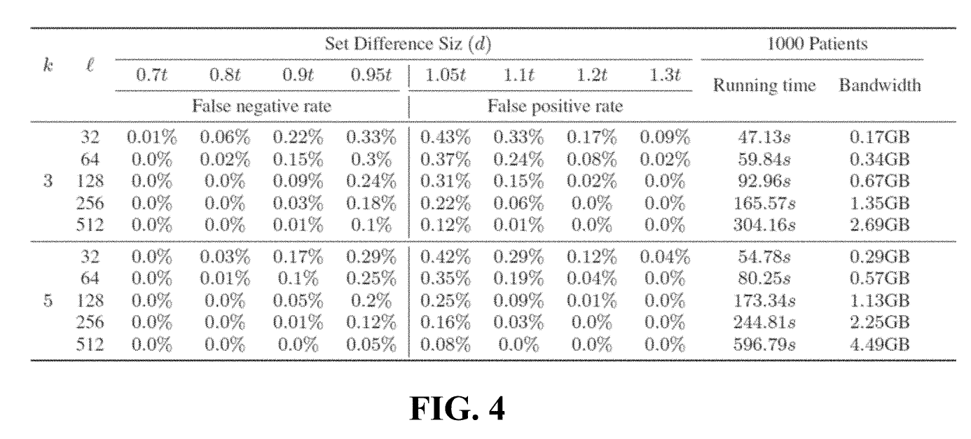

FIG. 4 and FIG. 5 show the performance of protocols 1 and 2 running over breast cancer patients' genomes (each of which is represented by a VCF file of roughly 150K variations). The private edit distance protocol is reduced to thresholding the set difference size of two sets, each containing 200K-300K single-character edits.

It was observed that the accuracy achieved was generally proportional to the value of kl (at least when the difference in k is small). Also note the asymmetry of errors in the range around the threshold. For instance, comparing the columns d=0.9t and d=1.1t, the false negative rates (on columns with d<t) is always smaller than the false positive rates (on columns with d>t) on their mirroring columns. This would be desirable in SPQ search as the users are usually more sensitive on false negatives (i.e., similar patients are overlooked) while tending to tolerate false positives (irrelevant patients are returned). Last, note that protocol 1 and 2 perform comparably in thresholding the set difference size, except that protocol 2 was about 30% faster, while protocol 1 was slightly better in terms of accuracy.

In the exemplified application of secure SPQ, it was assumed that there were 250 hospitals, each of which keeps 4,000 patient's records organized in 8 clusters. The first stage would check a total of 250×8=2,000 clusters. Assuming at most 5 hospitals will be selected as candidates to proceed in the second stage search, the searching will be through 4000×5=20,000 patient's records.

Since cluster centers have the same representation as patient genomes, the performance of the entire search for similar breast cancer patients is equivalent to checking 22,000 patients. Using protocol 2 with parameter k=5, 1=512, 22,000 edit-distance comparisons were accomplished within 183 minutes.

### Private Set Difference Size

In an SPQ scenario, calculating the set difference size with high precision is mostly unnecessary. However, once a similar patient is found, it may be worthwhile to calculate the edit distance with high accuracy to confirm the match. Moreover, many other personal genomic applications (such as genetic diagnosis and medical treatment risk prediction) may be useful to be able to precisely estimate edit distance in a privacy-preserving way.

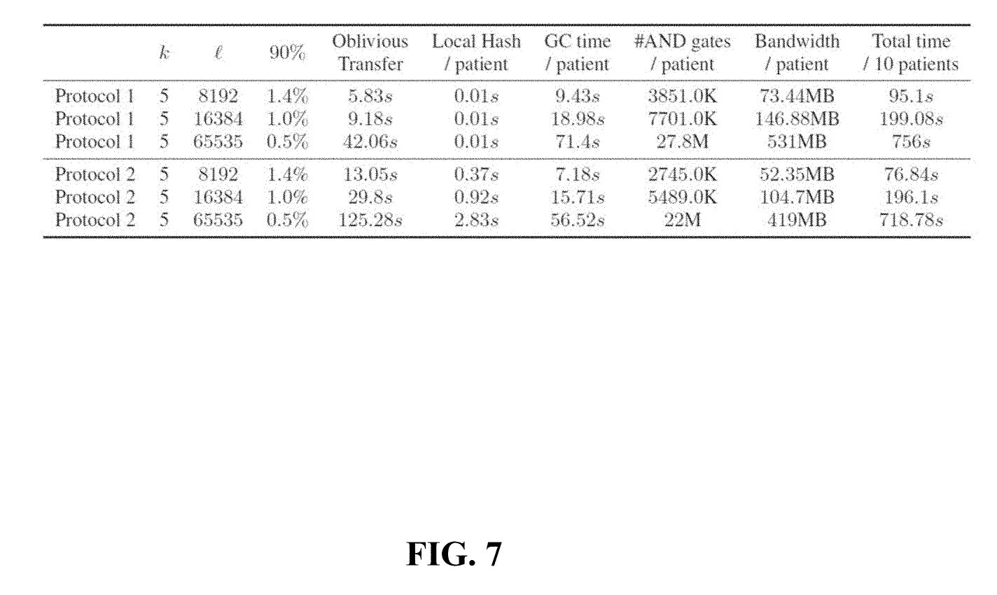

FIG. 7 shows the performance of protocol 1 and protocol 2 used in private set difference size estimation scenario. For each protocol, the cost to bound 90%-percentile error rate to 1% and 0.5% was reported, respectively. Thus, for 90% of the test cases, the relative error is less than or equal to 1% or 0.5% respectively. Under these circumstances, the results show that the protocols run significantly slower than private set difference size thresholding protocols. However, since the number of similar patients returned in the final stage is usually quite low (typically less than 10), users can afford much more time per candidate patients for obtaining an accurate distance.

With the optimized configuration of the exemplary protocols 1 and 2 discussed above, the cost of operating time may be independent of the number of patients on the hospital server. Therefore, the total running time to query n patients can be calculated as Timer_{Total}=Time_{OT}+n×(Time_{Local}+Time_{GC}). As can be seen, the total times reported in the figure conforms to the formula above with n=10.

### Experiments on Whole Genomes

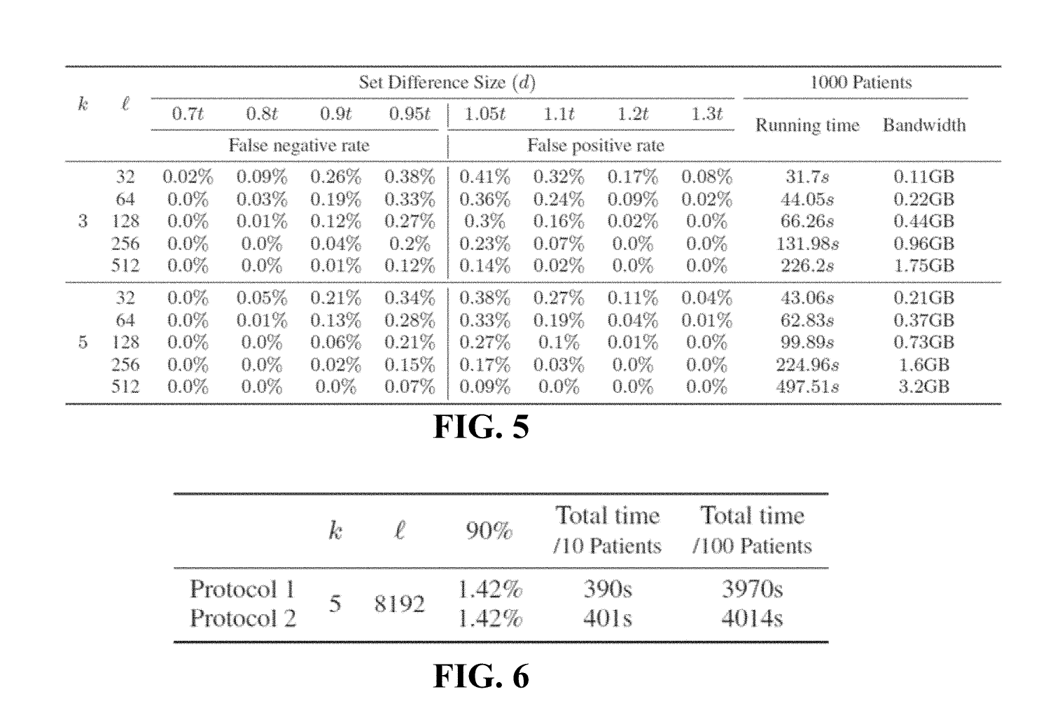

The performance of protocols 1 and 2 were also measured over whole-genomes obtained from the PGP project. FIG. 6 shows the total running time of these approaches on whole genomes. First, the timings for whole genome data were about 4 to 5 times slower than those of breast cancer tests, because the genomes considered in breast cancer tests are only a fraction ( 1/40) of whole genomes. The primary cause of the slowdown is the increased cost of garbled circuit generation and evaluation, since the bit length ω of the sums of the hashes is increased by a factor of around log 40≈5.3. Secondarily, the local hashing and oblivious transfer, whose costs grow linearly with the length of the input genomes, are 40 times more expensive.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. §112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method comprising:
securely calculating, by a processor in electrical communication with a genome registry, an edit-distance between a query private genome and a second private genome; and
securely calculating, by the processor, a set difference size between the query genome and the second private genome.

2. The method of claim 1, further comprising computing, by the processor, a set of single-character edits from the query genome and a public reference.

3. The method of claim 2, further comprising identifying, by the processor, preferred clusters by comparing a set of single-character edits with centers of recorded clusters.

4. The method of claim 1, wherein the edit sequence is contained on the genome registry.

5. The method of claim 1, further comprising comparing the set difference size with a predetermined threshold.

6. The method of claim 3, further comprising comparing the set difference size with a predetermined threshold.

7. The method of claim 1, wherein the genome registry is hashed.

8. The method of claim 7, wherein every set element is associated with a separate bucket.

9. The method of claim 1, further comprising square-free calculating, by the processor, a set difference.

10. A system comprising:
genomic registry data;
a processor; and
a non-transitory memory having instructions that, in response to an execution by the processor, cause the processor to
calculate a query edit sequence from a reference genome and a query genome; and
calculate a set difference size from the query edit sequence and a third party edit sequence stored on a server.

11. The system of claim 10, wherein the instructions further cause the processor to compute a set of single-character edits from the query edit sequence.

12. The system of claim 11, wherein the instructions further cause the processor to identify preferred clusters by comparing a query set of single-character edits with centers of recorded clusters.

13. The system of claim 10, wherein the instructions cause the processor to square-free compute a set difference.

14. A non-transitory computer readable storage medium bearing instructions for determining an edit distance between genomes, the instructions, when executed by a processor in electrical communication with a genome registry, cause the processor to perform operations comprising:
calculating a query edit-distance from a reference genome to a query genome; and
calculating, by the processor, a query set difference size between the query edit-distance and a server edit-distance, wherein the server edit-distance is calculated from a second genome on a server and the reference genome.

15. The non-transitory computer readable storage medium of claim 14, wherein the processor square-free computes a set difference.
